(19) United States
(12) Patent Application Publication
(10) Pub. No.: US 2018/0198768 A1
(43) Pub. Date: Jul. 12, 2018

(54) SYSTEM AND METHOD FOR PROVIDING AUTOMATED KEYCHAIN GROUPING AND UPDATING

(71) Applicant: Jose Luis Ibanez, Jr., Austin, TX (US)

(72) Inventor: Jose Luis Ibanez, Jr., Austin, TX (US)

(21) Appl. No.: 15/401,170

(22) Filed: Jan. 9, 2017

(51) Int. Cl. H04L 29/06

(52) U.S. Cl. CPC H04L 63/06; H04L 63/0861; H04L 63/083

(57) ABSTRACT

Embodiments of the present invention are generally directed towards providing systems and methods for grouping and updating of security key chains. In particular, embodiments of the present invention are configured to allow users to easily and automatically analyze, group and update keychains and associated applications with such keychains.

### FIELD OF THE INVENTION

Embodiments of the present invention are generally directed towards providing systems and methods for grouping and updating of security key chains. In particular, embodiments of the present invention are configured to allow users to easily and automatically analyze, group and update keychains and associated applications with such keychains.

### BACKGROUND

Computers, computing devices and electronic mediums have become ubiquitous and usage of applications, modules and other features requiring login or other authorization are utilized throughout almost every facet of interaction with such computers, computing devices and other electronic mediums.

With each feature requiring authorization, a different key, passcode, identifier or other form of verification may be required. In total, users may end up with dozens to hundreds of different access methods they use across all their various applications, modules or other features.

Currently, in order to ensure a user is able to access all of these features, a user must either memorize or somehow save their various security keys. This may result in the loss or otherwise jeopardizing of (e.g., via security breaches) security keys that could result in the unintentional disclosure of private or otherwise sensitive data, such as bank account information or other valuable information.

Further, when one security key is compromised, there is potential that an entire set of features is compromised as they may all share the same security key. When this occurs, there is no option but to manually review and update the security key associated with each individual feature that utilizes the compromised security key. All of this is time consuming and, unless conducted properly and timely, could leave certain features vulnerable to exploitation by anyone with the compromised security key data.

Finally, while there are password managers integrated into several software applications and other password managers available currently, each of these simply stores username and password combinations for use with specific features and none of them allow for any form of grouping or otherwise organizing, arranging or updating of security keychains to solve issues noted above.a

Therefore, there is need in the art for systems and methods for providing automated keychain grouping and updating in order to provide efficient control over and management of security keychains. These and other features and advantages of the present invention will be explained and will become obvious to one skilled in the art through the summary of the invention that follows.

### SUMMARY OF THE INVENTION

Accordingly, it is an aspect of the present invention to provide systems and methods for providing automated keychain grouping and updating in order to provide efficient control over and management of security keychains.

According to an embodiment of the present invention, a system for automated keychain grouping and updating comprises: a keychain control module, comprising computer-executable code stored in non-volatile memory; a processor; and one or more input means, wherein said keychain control module, said processor and said one or more input means are operably connected and are configured to: receive an application list, wherein said application list comprises a list of a plurality of applications, wherein each application of said plurality of applications utilizes one or more security keys; retrieve a plurality of security keys from said plurality of applications; identify one or more associations between said plurality of security keys and said plurality of applications; generate one or more keychain groupings based on said one or more associations between said plurality of security keys and said plurality of applications; provide to a user a set of generated keychain groupings based on said one or more keychain groupings; and formalize a plurality of keychain groupings based on said one or more keychain groupings and input from said user.

According to an embodiment of the present invention, the keychain control module, said processor and said one or more input means are further configured to receive a keychain group update request from said user.

According to an embodiment of the present invention, the processor and said one or more input means are further configured to retrieve a requested keychain group associated with a keychain group identified by said keychain group update request.

According to an embodiment of the present invention, the keychain control module, said processor and said one or more input means are further configured to identify one or more applications associated with said keychain group and an associated security key associated with each of said one or more applications.

According to an embodiment of the present invention, the keychain control module, said processor and said one or more input means are further configured to retrieve an updated security key from said keychain group update request.

According to an embodiment of the present invention, the keychain control module, said processor and said one or more input means are further configured to updat3 the associated security key associated with each of said one or more applications.

According to an embodiment of the present invention, the keychain control module, said processor and said one or more input means are further configured to transmit an updated security key to a remote computing device associated with a remote application selected from said one or more applications.

According to an embodiment of the present invention, the keychain control module, said processor and said one or more input means are further configured to receive confirmation from said remote application that said security key was successfully updated.

According to an embodiment of the present invention, wherein the plurality of security keys comprises individual security keys, wherein each individual security key is selected from a security key comprising a user name and password combination, a biometric identifier, a token, a unique identifier or a rolling security code.

According to an embodiment of the present invention, wherein at least one association selected from said one or more associations between said plurality of security keys and said plurality of applications comprises a matching of security key between two or more applications, a matching of application provider between two or more applications and a matching of application type between two or more applications.

According to an embodiment of the present invention, a method for automated keychain grouping and updating, the method comprising the steps of: receiving an application list, wherein said application list comprises a list of a plurality of applications, wherein each application of said plurality of applications utilizes one or more security keys; retrieving a plurality of security keys from said plurality of applications; identifying one or more associations between said plurality of security keys and said plurality of applications; generating one or more keychain groupings based on said one or more associations between said plurality of security keys and said plurality of applications; providing to a user a set of generated keychain groupings based on said one or more keychain groupings; and formalizing a plurality of keychain groupings based on said one or more keychain groupings and input from said user.

According to an embodiment of the present invention, the method further comprises the step of receiving a keychain group update request from said user.

According to an embodiment of the present invention, the method further comprises the step of retrieving a requested keychain group associated with a keychain group identified by said keychain group update request.

According to an embodiment of the present invention, the method further comprises the step of identifying one or more applications associated with said keychain group and an associated security key associated with each of said one or more applications.

According to an embodiment of the present invention, the method further comprises the step of retrieving an updated security key from said keychain group update request.

According to an embodiment of the present invention, the method further comprises the step of updating the associated security key associated with each of said one or more applications.

According to an embodiment of the present invention, the method further comprises the step of transmitting an updated security key to a remote computing device associated with a remote application selected from said one or more applications.

According to an embodiment of the present invention, the method further comprises the step of receiving confirmation from said remote application that said security key was successfully updated.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a schematic of a system for providing automated keychain grouping and updating, in accordance with an embodiment of the present invention;

FIG. 4 illustrates a schematic of a system for providing automated keychain grouping and updating, in accordance with an embodiment of the present invention;

FIG. 5 is a process flow of an exemplary method in accordance with embodiments of the present invention; and

FIG. 6 is a process flow of an exemplary method in accordance with embodiments of the present invention.

### DETAILED SPECIFICATION

According to an embodiment of the present invention, the systems and methods described herein are generally directed towards providing grouping and updating of security key chains. In particular, embodiments of the present invention are configured to allow users to easily and automatically analyze, group and update keychains and associated applications with such keychains.

In particular, embodiments of the present invention are configured to provide users of computing devices the ability to automatically scan, identify, list, group and update keychains in a convenient and efficient manner. Keychains are security keys that provide access to one or more functions on a computing device. Functions may include, but are not limited to, applications, websites requiring login or other security provisioning to access, social media platforms, integrated systems on the computing device (e.g., system administration), or any combination thereof. One of ordinary skill in the art would appreciate that there are numerous types of functions available on a computing device that could require a keychain to access, and embodiments of the present invention are contemplated for use with any appropriate function and keychain type.

In a preferred embodiment, the system may be configured to scan for all available keychains on a computing device. Scanning for available keychains may include, but is not limited to, scanning web browser password repositories, scanning application configuration files, scanning application security files, accessing security repositories associated with the computing device of a user, or any combination thereof. In some cases, user input may be required to access a keychain in a feature for the first time. After the first access, the system will have access to the feature via the keychain provided by the user and may be able to login and manage that feature automatically in the future.

According to an embodiment of the present invention, the system is further configured to provide groupings for the plurality of features identified from scanning the computing device. Grouping of features may be done in numerous means. In a first embodiment, features may be grouped by shared keychains (e.g., features with the same user name and password combinations). In a second embodiment, features may be grouped by feature developer (e.g., grouping software applications developed by a single software developer). In a third embodiment, features may be grouped by feature type (e.g., grouping features related to productivity together, grouping features related to entertainment together, grouping features related to finance together). In other embodiments, groupings can be made in a variety of manners, including combinations of the aforementioned embodiments. In still further embodiments, groupings of features may be done on a tiered basis (e.g., first by feature type then by shared keychains). One of ordinary skill in the art would appreciate that there are numerous manners in which the system could provide groupings, and embodiments of the present invention are contemplated for use with any appropriate type of feature grouping.

Once grouped, embodiments of the present invention are configured to allow for users to easily update keychain groupings. In preferred embodiments of the present invention, the system may allow a user the ability to provide a single (or limited number of) request to update a keychain grouping and the system will affect the update across all features associated with that keychain grouping. In this, the system may be configured to login or otherwise access or interact with (e.g., such as via an Application Programming Interface (API)) a feature or a remote computing device/service (e.g., website) in order to update the security keychain for that feature or remote computing device/service. Advantageously, this allows embodiments of the present invention the ability to quickly and efficiently monitor and maintain security keychain groupings without having to access each individual feature to update the keychain. This is extremely useful, particularly when a security keychain becomes compromised.

Further, in preferred embodiments of the present invention, the system is configured to provide the user with numerous graphical user interfaces (GUIs) to allow for the updating, generation or modification of, or other maintenance of the keychain groupings. Such interfaces may allow the user the ability to not only select and easily create or update keychain groupings, but also modify existing keychain groupings and assignment of various features to certain groups.

In certain embodiments, the system may be configured to ensure that a selected or updated keychain meets the criteria for all associated features. For instance, if a feature requires a passcode with at least one upper case character and one number, the system can ensure that any attempted security keychain has at least these features. This is true across all features in a grouping, so that the system can ensure that a provided security keychain for an update would be sufficient for all grouped features. If not, the system may request a new security keychain from the user.

In still further embodiments, the system may be configured to aggregate the requirements of the features in the grouping and provide to the user the minimum (and maximum) requirements for a security keychain. For instance, since various features may have different requirements, the system may aggregate these requirements and present a user with the minimum number of characters and special characters they can use for a particular group passcode keychain, as well as maximum number of characters and special characters (or character restrictions). Advantageously, this allows the user to be able to quickly and conveniently select a security keychain that works for all the features in a grouping.

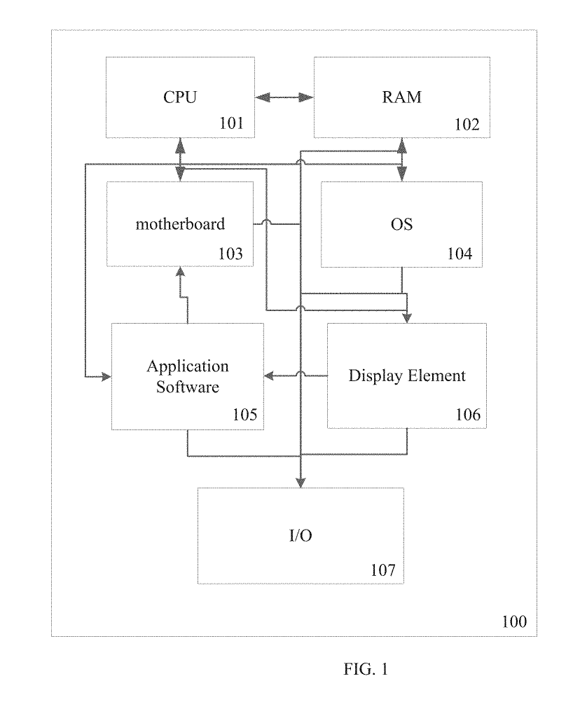

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smart phones, laptops, mobile computing devices and tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

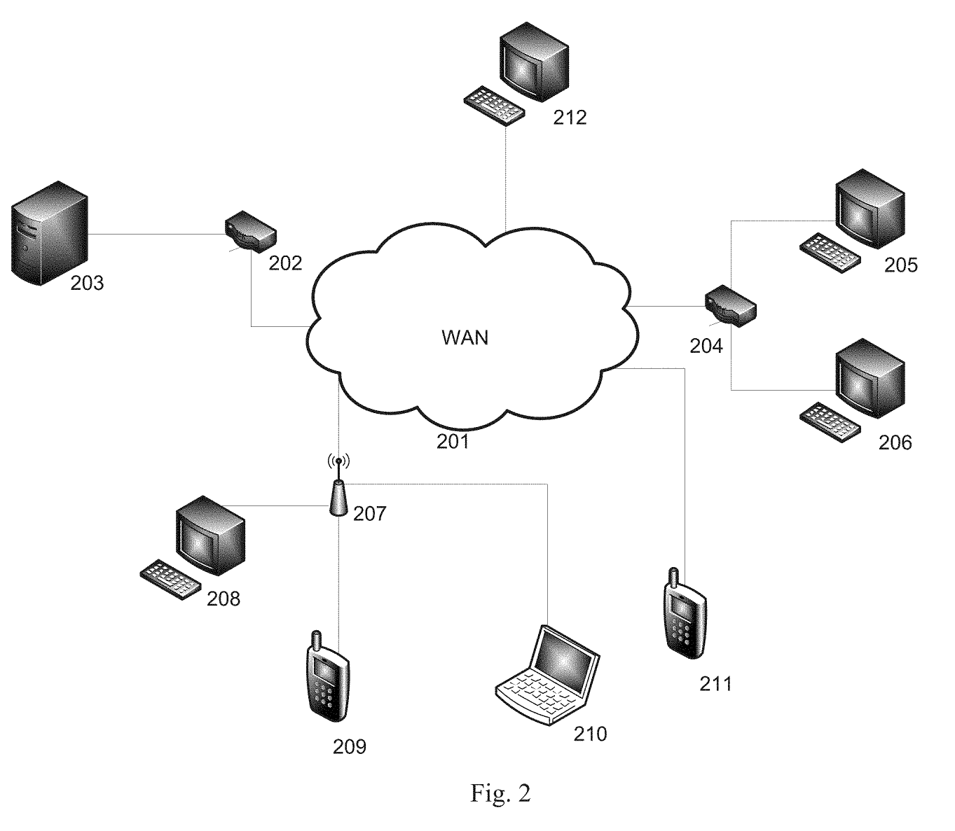

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, WiFi, Bluetooth, etc.).

According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

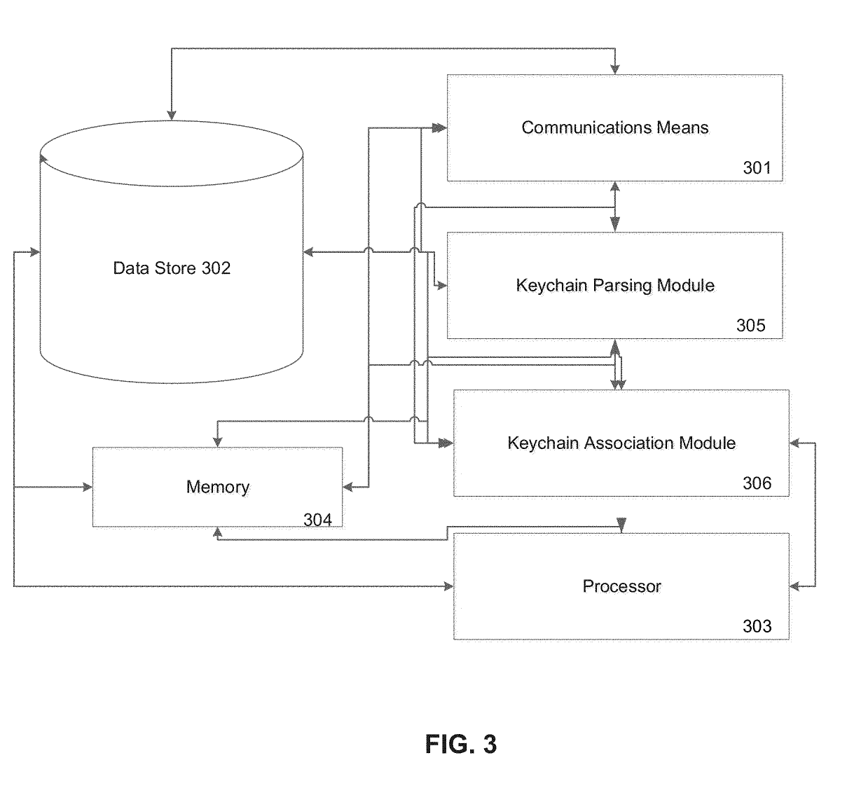

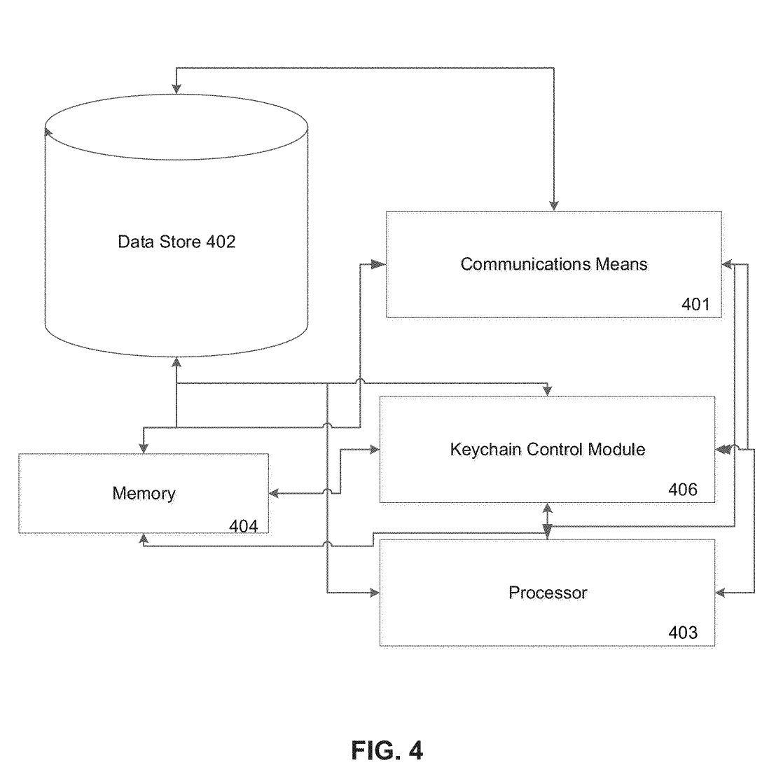

Turning to FIG. 3, according to an embodiment of the present invention, a system for providing automated keychain grouping and updating is comprised of one or more communications means 301, one or more data stores 302, a processor 303, memory 304, a keychain parsing module 305 and a keychain association module 306. In FIG. 4B, according to an embodiment of the present invention, a system for providing automated keychain grouping and updating is comprised of one or more communications means 401, one or more data stores 402, a processor 403, memory 404 and a keychain control module 406. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, circuitry purposed for the means of communicating data over one or more networks or to one or more peripheral devices attached to the system. Appropriate communications means may include, but are not limited to, circuitry and or other electronics or combinations of software, hardware and individual elements thereof, each providing for one or more wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the keychain parsing module is configured to access features present on a computing device (as well as those features provided remotely through the computing device, such as websites) and retrieve keychains from each feature. Once the keychain parsing module has retrieved each of the available keychains, the module will generate a list of available features and keychains for use in developing keychain groupings. The keychain parsing module may also be configured to retrieve information about each feature identified on the system. Information about the features may include, but is not limited to, provision type (e.g., local, remote), feature provider (e.g., software developer, hardware developer), feature classification (e.g., productivity, entertainment, finance, video, music, system, device), keychain type (e.g., user/password, touch ID, biometric ID, other cryptographic means), or any combination thereof. One of ordinary skill in the art would appreciate that there are numerous types of information about features that could be retrieved and parsed by the keychain parsing module, and embodiments of the present invention are contemplated for use with any appropriate type of information.

According to an embodiment of the present invention, the keychain association module is configured to utilize the parsed feature and keychain information to generate associations and ultimately generate keychain groupings. As detailed elsewhere herein, the keychain association module, in conjunction with the system, may form potential or final keychain groupings based on information retrieved and parsed related to the plurality of features available on a computing device. The keychain association module further allows for users to interact with the groupings and affect updates and reorganizations of such keychain groupings, such as via one or more GUIs.

### EXEMPLARY EMBODIMENTS

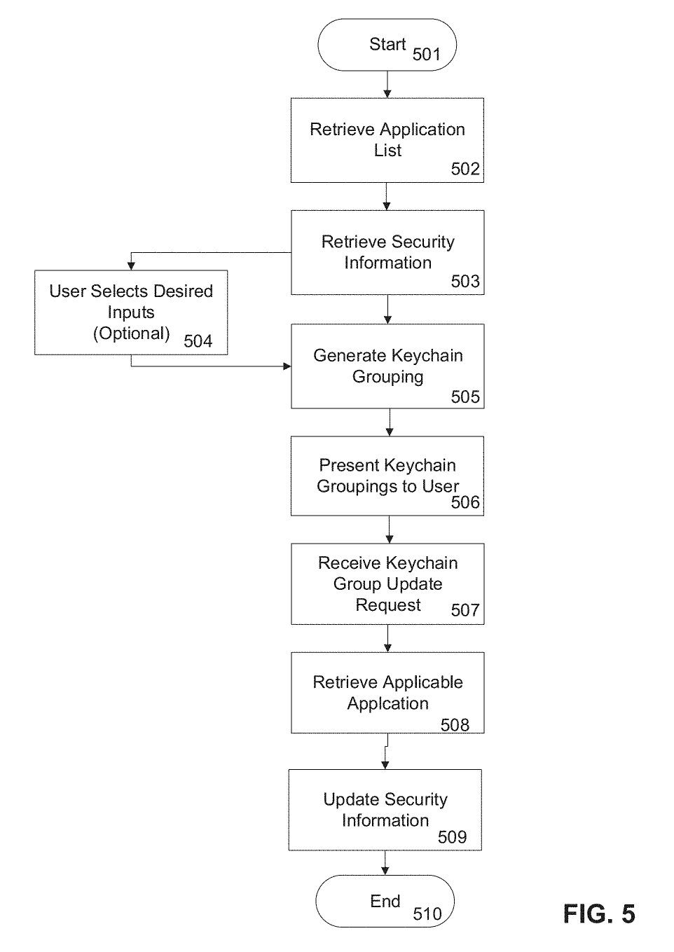

Turning now to FIG. 5, an exemplary method for providing automated keychain grouping and updating is shown. The process starts at step 501 with a user requesting the generation of a keychain grouping on a computing device. At this point, the system begins by processing the request and retrieving a list of applications and features on or associated with the computing device, both local and remote (step 502). The processing of applications and features may include scanning through system features, application features, remote features (e.g., website logins), hardware features, and other available features that have associated security keychain information with them.

At step 503, the system retrieves the security information associated with each feature and associates the security information with the identified feature. In certain cases, the system may require input from the user in order to retrieve the security information, such as where the security information requires login to the feature in order to retrieve, or where the security information may be associated with the user (e.g., biometric information). Optionally, at step 504, the user will select which identified features the user wishes to have grouping generated for.

At step 505, the system generates the keychain groupings for the features identified (and optionally as narrowed by the user in step 504). The groupings of features may be done in accordance with the embodiments described earlier herein, such as based on similar keychain information, similar feature types, similar feature information, or any combination thereof.

At step 506, the system presents the keychain grouping to the user, generally via one or more GUIs. The user can then approve or otherwise modify the keychain groupings as they see fit and most advantageous to them.

At step 507, the system receives a keychain group update request, such as when a user wants to update a security keychain for a group of features. At step 508, the system retrieves applicable information from both the computing device and the keychain group update request.

At step 509, the system updates the security keychain information for the identified keychain group. This may include contacting and updating security keychain information on local and/or remote computing devices (e.g., updating logins on a website, updating login information on a local computing device). Once completed, the process terminates at step 510.

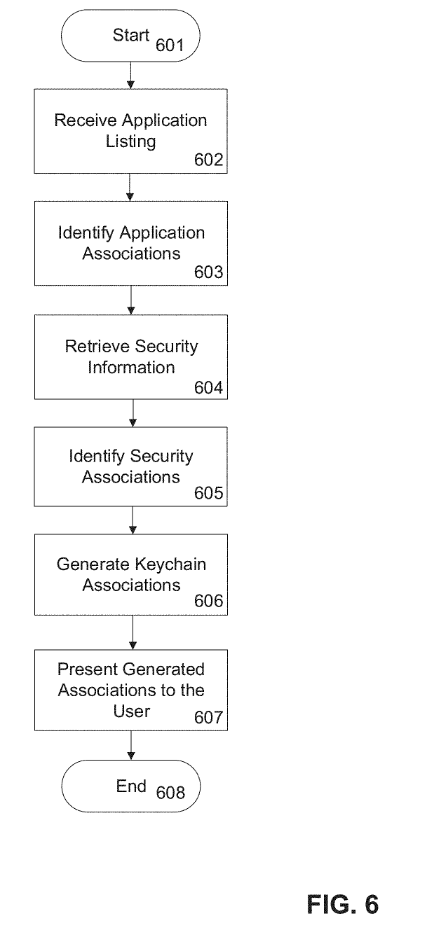

Turning now to FIG. 6, an exemplary method for providing automated keychain grouping and updating is shown. The process is a modification of the process shown in FIG. 5 and starts at step 601 with a user requesting generation of a keychain grouping. At this point, the system begins by processing the request and retrieving a list of applications and features on or associated with the computing device, both local and remote (step 602). The processing of applications and features may include scanning through system features, application features, remote features (e.g., website logins), hardware features, and other available features that have associated security keychain information with them.

At step 603, the system identifies associations related to each of the identified features. Associations may include, but are not limited to, information about how various features interrelate with one another, such as developer, feature classification, security keychain types, update types available, proprietary associations (e.g., previously generated associations, either by user or via a keychain group community), usage information about features (e.g., rarely used features, frequently used features), or any combination thereof. One of ordinary skill in the art would appreciate that there are numerous associations that could be identified and utilized in embodiments of the present invention.

At step 604, the system retrieves the security information associated with each feature and associates the security information with the identified feature. In certain cases, the system may require input from the user in order to retrieve the security information, such as where the security information requires login to the feature in order to retrieve, or where the security information may be associated with the user (e.g., biometric information).

At step 606, the system generates the keychain groupings for the features identified. The groupings in this case are based, at least in part, on the identified associations from step 605. The system may generate one or more keychain groupings based on certain associations and weighting of importance thereof. For instance, similarities in feature classification may be weighed more heavily than security information.

At step 607, the system presents the keychain grouping to the user, generally via one or more GUIs. The user can then approve or otherwise modify the keychain groupings as they see fit and most advantageous to them. It should be noted, that optionally, in certain embodiments, once keychain groupings are created (or prior thereto), the system may be configured to update and synchronize the security keychain across a grouping such that each feature in the grouping has the same security keychain. Once completed, the process terminates at step 608.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for automated keychain grouping and updating, the system comprising:
a keychain control module, comprising computer-executable code stored in non-volatile memory;
a processor; and
one or more input means,
wherein said keychain control module, said processor and said one or more input means are operably connected and are configured to:
receive an application list, wherein said application list comprises a list of a plurality of applications, wherein each application of said plurality of applications utilizes one or more security keys;
retrieve a plurality of security keys from said plurality of applications;
identify one or more associations between said plurality of security keys and said plurality of applications;
generate one or more keychain groupings based on said one or more associations between said plurality of security keys and said plurality of applications;
provide to a user a set of generated keychain groupings based on said one or more keychain groupings; and
formalize a plurality of keychain groupings based on said one or more keychain groupings and input from said user.

2. The system of claim 1, wherein said keychain control module, said processor and said one or more input means are further configured to receive a keychain group update request from said user.

3. The system of claim 2, wherein said keychain control module, said processor and said one or more input means are further configured to retrieve a requested keychain group associated with a keychain group identified by said keychain group update request.

4. The system of claim 13, wherein said keychain control module, said processor and said one or more input means are further configured to identify one or more applications associated with said keychain group and an associated security key associated with each of said one or more applications.

5. The system of claim 4, wherein said keychain control module, said processor and said one or more input means are further configured to retrieve an updated security key from said keychain group update request.

6. The system of claim 5, wherein said keychain control module, said processor and said one or more input means are further configured to updat3 the associated security key associated with each of said one or more applications.

7. The system of claim 6, wherein said keychain control module, said processor and said one or more input means are further configured to transmit an updated security key to a remote computing device associated with a remote application selected from said one or more applications.

8. The system of claim 7, wherein said keychain control module, said processor and said one or more input means are further configured to receive confirmation from said remote application that said security key was successfully updated.

9. The system of claim 1, wherein said plurality of security keys comprises individual security keys, wherein each individual security key is selected from a security key comprising a user name and password combination, a biometric identifier, a token, a unique identifier or a rolling security code.

10. The system of claim 1, wherein at least one association selected from said one or more associations between said plurality of security keys and said plurality of applications comprises a matching of security key between two or more applications, a matching of application provider between two or more applications and a matching of application type between two or more applications.

11. A method for automated keychain grouping and updating, the method comprising the steps of:
receiving an application list, wherein said application list comprises a list of a plurality of applications, wherein each application of said plurality of applications utilizes one or more security keys;
retrieving a plurality of security keys from said plurality of applications;
identifying one or more associations between said plurality of security keys and said plurality of applications;
generating one or more keychain groupings based on said one or more associations between said plurality of security keys and said plurality of applications;
providing to a user a set of generated keychain groupings based on said one or more keychain groupings; and
formalizing a plurality of keychain groupings based on said one or more keychain groupings and input from said user.

12. The method of claim 11, further comprising the step of receiving a keychain group update request from said user.

13. The method of claim 12, further comprising the step of retrieving a requested keychain group associated with a keychain group identified by said keychain group update request.

14. The method of claim 13, further comprising the step of identifying one or more applications associated with said keychain group and an associated security key associated with each of said one or more applications.

15. The method of claim 14, further comprising the step of retrieving an updated security key from said keychain group update request.

16. The method of claim 15, further comprising the step of updating the associated security key associated with each of said one or more applications.

17. The method of claim 16, further comprising the step of transmitting an updated security key to a remote computing device associated with a remote application selected from said one or more applications.

18. The method of claim 16, further comprising the step of receiving confirmation from said remote application that said security key was successfully updated.

19. The method of claim 11, wherein said plurality of security keys comprises individual security keys, wherein each individual security key is selected from a security key comprising a user name and password combination, a biometric identifier, a token, a unique identifier or a rolling security code.

20. The method of claim 11, wherein at least one association selected from said one or more associations between said plurality of security keys and said plurality of applications comprises a matching of security key between two or more applications, a matching of application provider between two or more applications and a matching of application type between two or more applications.
